(19) United States
(12) Patent Application Publication
(10) Pub. No.: US 2013/0007083 A1
(43) Pub. Date: Jan. 3, 2013

(54) SYSTEMS AND METHODS FOR COMPUTING CONTINUOUS WAVELET TRANSFORM ON A DEDICATED INTEGRATED CIRCUIT

(75) Inventors: Peter Galen, Portland, OR (US); James Ochs, Seattle, WA (US); James Watson, Dunfermline (GB); Tom Wilmering, Westminster, CO (US); Paul Addison, Edinburgh (GB)

(73) Assignee: Nellcor Puritan Bennett Ireland, Mervue (IE)

(21) Appl. No.: 13/174,354

(22) Filed: Jun. 30, 2011

(51) Int. Cl. G06F 17/14

(52) U.S. Cl. 708/400

(57) ABSTRACT

Methods and systems are disclosed for computing one or more continuous wavelet transforms on a dedicated integrated circuit. The systems comprise an integrated circuit having a receiver, memory, and processing circuitry. The receiver receives input data corresponding to an input signal. The memory stores information corresponding to one or more wavelet functions scaled over a set of scales. The processing circuitry is configured to compute, in-parallel, various portions of a single continuous wavelet transform of the input signal based on the received input data and the stored information corresponding to a single wavelet function computed over a set of scales.

### SUMMARY OF THE DISCLOSURE

The present disclosure relates to signal processing and analysis and, more particularly, the present disclosure relates to a system and method for computing a continuous wavelet transform (“CWT”) on a dedicated integrated circuit.

In one aspect, a system for computing a single continuous wavelet transform is provided with an integrated circuit having a receiver, memory, and processing circuitry. The receiver receives data corresponding to an input signal. The memory stores information corresponding to a wavelet function scaled over a set of scales. The processing circuitry is configured to compute, in-parallel, portions of a CWT of the input signal based on the received input data and the stored, scaled wavelet functions. The processing circuitry may comprise a plurality of arithmetic logic units (“ALUs”), where each ALU may be configured to compute the CWT of the input signal using a wavelet function at a particular scale.

In some implementations, the ALU comprises at least a buffer that stores an input signal from the receiver, at least one memory element that stores information corresponding to a first scaled version of a wavelet function, and a multiply-and-accumulate unit connected to the buffer and the memory element. The at least one multiplier takes the dot product of the stored, scaled wavelet function and the input data to generate a resultant CWT value.

In another aspect, a system for computing one or more CWTs is provided. The system includes an integrated circuit having a receiver, memory, and processing circuitry. The receiver receives input data corresponding to an input signal. The memory stores information corresponding to one or more wavelet functions, each scaled over a set of scales. The processing circuitry computes, in parallel, a separate continuous wavelet transform of the input signal for each of the one or more wavelet functions across the set of scales. The one or more processing units may output to a user interface a one or more scalograms corresponding to the one or more wavelet transforms computed using the one or more wavelet functions. The processing circuitry further comprises circuitry corresponding to a selector configured to select one of the one or more continuous wavelet transforms as a most optimal continuous wavelet transform for the input signal based on the one or more scalograms.

Methods and systems for computing one or more continuous wavelet transforms on a dedicated integrated circuit are disclosed herein. In a patient monitoring setting, a CWT of an input signal may be used to determine physiological information of the signal in a variety of clinical applications, including within diagnostic and predictive models, and may be recorded and/or displayed by a patient monitor.

### BRIEF DESCRIPTION OF THE DRAWINGS

The above and other features of the present disclosure, its nature, and various advantages will be more apparent upon consideration of the following detailed description, taken in conjunction with the accompanying drawings in which:

FIG. 1 shows an illustrative pulse oximetry system;

FIG. 2 is a block diagram of the illustrative pulse oximetry system of FIG. 1 coupled to a patient;

FIGS. 3(a) and 3(b) show illustrative views of a scalogram derived from a CWT of a photoplethsmograph (“PPG”) signal;

FIG. 3(c) shows an illustrative scalogram derived from a signal containing two pertinent components;

FIG. 3(d) shows an illustrative schematic of signals associated with a ridge in FIG. 3(e);

FIG. 4 shows a block diagram of an architecture of an integrated circuit for performing a CWT of an input signal;

FIG. 5 shows a detailed block diagram of a complex ALU for computing a single CWT of an input signal using a single wavelet function at a particular scale;

FIG. 6 shows a block diagram of data arrays for storing computed CWT values of an input signal;

FIG. 7 is a system level block diagram of an OEM module that uses a CWT integrated circuit for computing one or more physiological parameters;

FIG. 8 shows a schematic of a wavelet function used in, for example, the CWT system described in relation to FIGS. 4-5.

### DETAILED DESCRIPTION

An oximeter is a medical device that may determine the oxygen saturation of the blood. One common type of oximeter is a pulse oximeter, which may indirectly measure the oxygen saturation of a patient's blood (as opposed to measuring oxygen saturation directly by analyzing a blood sample taken from the patient) and changes in blood volume in the skin. Ancillary to the blood oxygen saturation measurement, pulse oximeters may also be used to measure the pulse rate of the patient. Pulse oximeters typically measure and display various blood flow characteristics including, but not limited to, the oxygen saturation of hemoglobin in arterial blood.

An oximeter may include a light sensor that is placed at a site on a patient, typically on a fingertip, toe, forehead, or earlobe, or in the case of a neonate, across a foot. The oximeter may pass light from a light source through blood perfused tissue and photoelectrically sense the absorption of light in the tissue. For example, the oximeter may measure the intensity of light that is received at the light sensor as a function of time. An input signal representing light intensity versus time or a mathematical manipulation of this signal (e.g., a scaled version thereof, a log taken thereof, a scaled version of a log taken thereof) may be referred to as the photoplethysmograph (PPG) signal. In addition, the term “PPG signal,” as used herein, may also refer to an absorption signal (i.e., representing the amount of light absorbed by the tissue) or any suitable mathematical manipulation thereof. The PPG signal may be used to calculate the amount of the blood constituent (e.g., oxyhemoglobin) being measured, the pulse rate, as well as a number of other physiological parameters, including blood pressure, cardiac output, respiration rate, respiration effort, regional saturation, glucose, and perfusion/pulse amplitude amongst others.

The light passed through the tissue is selected to be of one or more wavelengths that are absorbed by the blood in an amount representative of the amount of the blood constituent present in the blood. The amount of light passed through the tissue varies in accordance with the changing amount of blood constituent in the tissue and the related light absorption. Red and infrared wavelengths may be used because it has been observed that highly oxygenated blood will absorb relatively less red light and more infrared light than blood with a lower oxygen saturation. By comparing the intensities of two wavelengths at different points in the pulse cycle, it is possible to estimate the blood oxygen saturation of hemoglobin in arterial blood.

When the measured blood parameter is the oxygen saturation of hemoglobin, a convenient starting point assumes a saturation calculation based on Lambert-Beer's law. The following notation will be used herein:

I(λ,t)=I_{O}(λ)exp(−(sβ_{O}(λ)+(1−s)βᵣ(λ))l(t)) (1)

where:
λ=wavelength;
t=time;
I=intensity of light detected;
I_{O}=intensity of light transmitted;
s=oxygen saturation;
β_{O}, βᵣ=empirically derived absorption coefficients; and
l(t)=a combination of concentration and path length from emitter to detector as a function of time.

Traditional pulse oximetry measures light absorption at two wavelengths (e.g., red and infrared (IR)), and then calculates saturation by solving for the “ratio of ratios” as follows.

1. First, the natural logarithm of (1) is taken (“log” will be used to represent the natural logarithm) for IR and Red

log I=log I_{O}−(sβ_{O}+(1−s)βᵣ)l (2)

2. (2) is then differentiated with respect to time

$$\frac{d log I}{d t} = - ( s {β}_{o} + ( 1 - s ) {β}_{r} ) \frac{d l}{d t} \qquad ( 3 )$$

3. Red (3) is divided by IR (3)

$$\frac{\frac{d log I ( {λ}_{R} )}{d t}}{\frac{d log I ( {λ}_{IR} )}{d t}} = \frac{s {β}_{o} ( {λ}_{R} ) + ( 1 - s ) {β}_{r} ( {λ}_{R} )}{s {β}_{o} ( {λ}_{IR} ) + ( 1 - s ) {β}_{r} ( {λ}_{IR} )} \qquad ( 4 )$$

### 4. Solving for s

$$s = \frac{\frac{d log I ( {λ}_{IR} )}{d t} {β}_{r} ( {λ}_{R} ) - \frac{d log I ( {λ}_{R} )}{d t} {β}_{r} ( {λ}_{IR} )}{\frac{d log I ( {λ}_{R} )}{d t} ( {β}_{o} ( {λ}_{IR} ) - {β}_{r} ( {λ}_{IR} ) ) - \frac{d log I ( {λ}_{IR} )}{d t} ( {β}_{o} ( {λ}_{R} ) - {β}_{r} ( {λ}_{R} ) )}$$

Note in discrete time

$$\frac{d log I ( λ , t )}{d t} ≃ log I ( λ , {t}_{2} ) - log I ( λ , {t}_{1} )$$

### Using log A-log B=log A/B,

$$\frac{d log I ( λ , t )}{d t} ≃ log ( \begin{matrix}I ( {t}_{2} , λ ) \\ I ( {t}_{1} , λ )\end{matrix} )$$

So, (4) can be rewritten as

$$\frac{\frac{d log I ( {λ}_{R} )}{d t}}{\frac{d log I ( {λ}_{IR} )}{d t}} ≃ \frac{log ( \frac{I ( {t}_{1} , {λ}_{R} )}{I ( {t}_{2} , {λ}_{R} )} )}{log ( \frac{I ( {t}_{1} , {λ}_{IR} )}{I ( {t}_{2} , {λ}_{IR} )} )} = R \qquad ( 5 )$$

where R represents the “ratio of ratios.” Solving (4) for s using (5) gives

$$s = \frac{{β}_{r} ( {λ}_{R} ) - R {β}_{r} ( {λ}_{IR} )}{R ( {β}_{o} ( {λ}_{IR} ) - {β}_{r} ( {λ}_{IR} ) ) - {β}_{o} ( {λ}_{R} ) + {β}_{r} ( {λ}_{R} )} .$$

From (5), R can be calculated using two points (e.g., PPG maximum and minimum), or a family of points. One method using a family of points uses a modified version of (5). Using the relationship

$$\frac{d log I}{d t} = \frac{\frac{d I}{d t}}{I} \qquad ( 6 )$$

now (5) can be written as

$$\begin{matrix}\frac{\frac{d log I ( {λ}_{R} )}{d t}}{\frac{d log I ( {λ}_{IR} )}{d t}} ≃ \frac{\frac{I ( {t}_{2} , {λ}_{R} ) - I ( {t}_{1} , {λ}_{R} )}{I ( {t}_{1} , {λ}_{R} )}}{\frac{I ( {t}_{2} , {λ}_{IR} ) - I ( {t}_{1} , {λ}_{IR} )}{I ( {t}_{1} , {λ}_{IR} )}} \\ = \frac{[ I ( {t}_{2} , {λ}_{R} ) - I ( {t}_{1} , {λ}_{R} ) ] I ( {t}_{1} , {λ}_{IR} )}{[ I ( {t}_{2} , {λ}_{IR} ) - I ( {t}_{1} , {λ}_{IR} ) ] I ( {t}_{1} , {λ}_{R} )} \\ = R\end{matrix} \qquad ( 7 )$$

which defines a cluster of points whose slope of y versus x will give R where

x(t)=[I(t₂,λ_{IR})−I(t₁,λ_{IR})]I(t₁,λ_{R})

y(t)=[I(t₂,λ_{R})−I(t₁,λ_{R})]I(t₁,λ_{IR})

y(t)=Rx(t) (8)

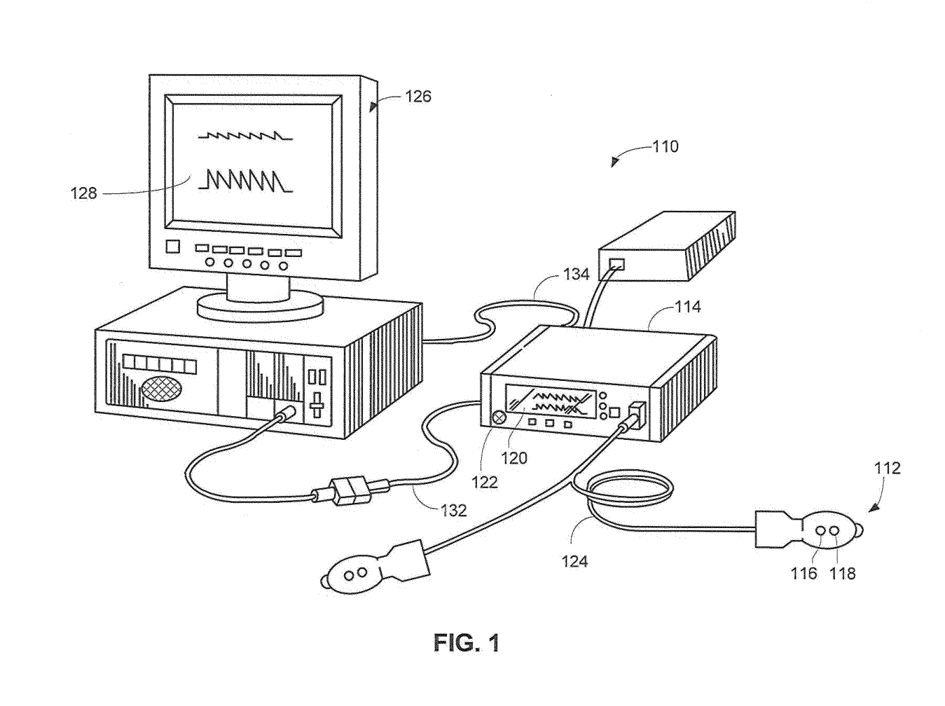

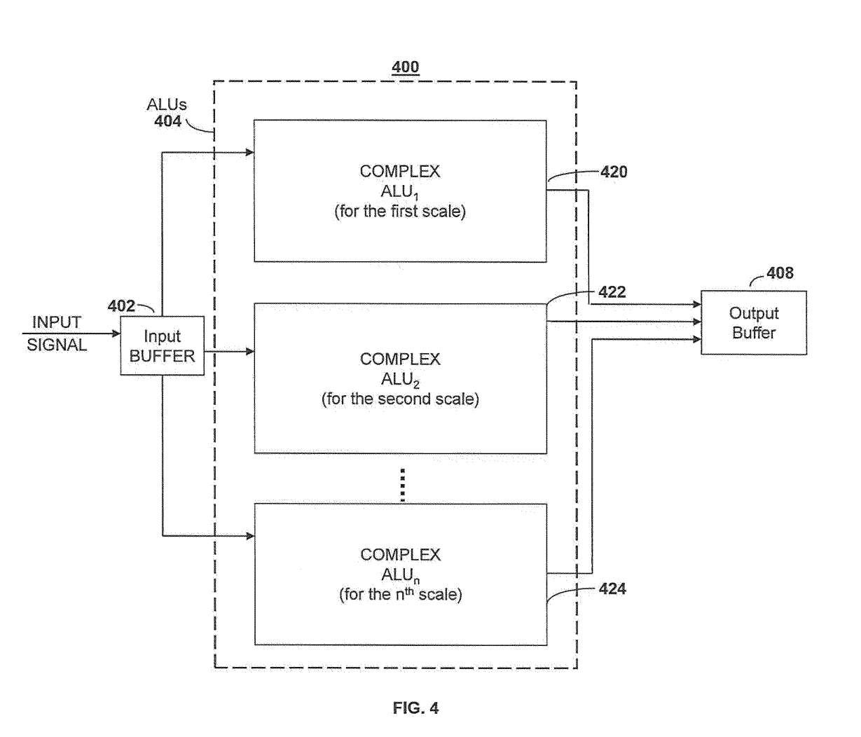

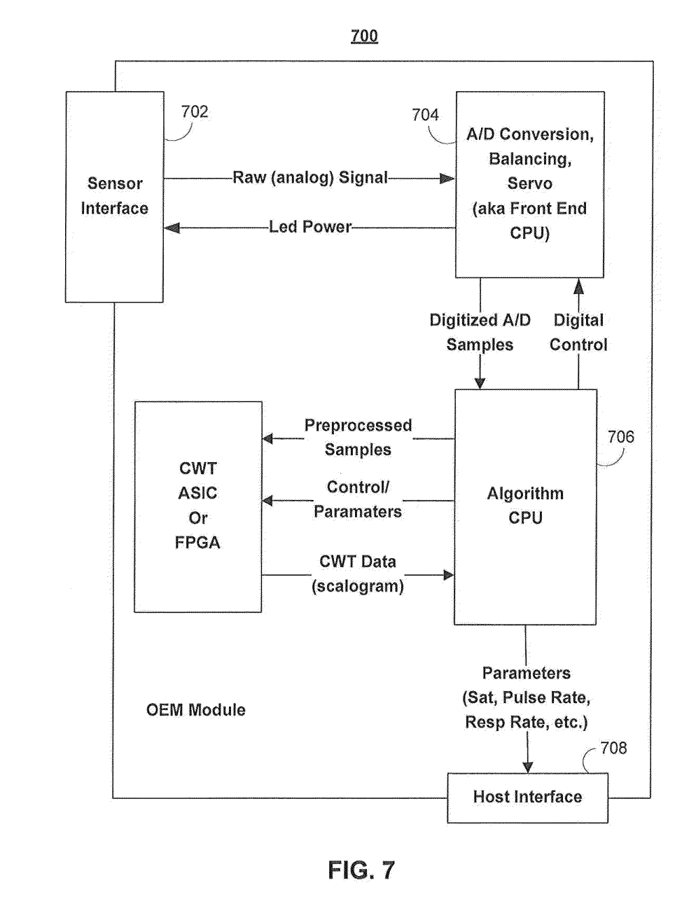

FIG. 1 shows an illustrative pulse oximetry system for generating an input signal that may be processed by a CWT integrated circuit, for example, the CWT integrated circuit described in relation to FIGS. 4-6. System 110 may include a sensor 112 and a pulse oximetry monitor 114. Sensor 112 includes an emitter 116 for emitting light at two or more wavelengths into a patient's tissue. A detector 118 may also be provided in sensor 112 for detecting the light originally from emitter 116 that emanates from the patient's tissue after passing through the tissue. In certain embodiments, the sensor 112 is either connected to or comprises as part of a sensor interface, such as the sensor interface described in relation to FIG. 7.

According to another embodiment, and as will be described, system 110 may include a plurality of sensors forming a sensor array in lieu of single sensor 112. Each of the sensors of the sensor array may be a complementary metal oxide semiconductor (CMOS) sensor. Alternatively, each sensor of the array may be charged coupled device (CCD) sensor. In another embodiment, the sensor array may be made up of a combination of CMOS and CCD sensors. The CCD sensor may comprise a photoactive region and a transmission region for receiving and transmitting data whereas the CMOS sensor may be made up of an integrated circuit having an array of pixel sensors. Each pixel may have a photodetector and an active amplifier.

According to an embodiment, emitter 116 and detector 118 may be on opposite sides of a digit such as a finger or toe, in which case the light that is emanating from the tissue has passed completely through the digit. In an embodiment, emitter 116 and detector 118 may be arranged so that light from emitter 116 penetrates the tissue and is reflected by the tissue into detector 118, such as a sensor designed to obtain pulse oximetry data from a patient's forehead.

In an embodiment, the sensor or sensor array may be connected to and draw its power from monitor 114 as shown. In another embodiment, the sensor may be wirelessly connected to monitor 114 and include its own battery or similar power supply (not shown). Monitor 114 may be configured to calculate physiological parameters based at least in part on data received from sensor 112 relating to light emission and detection. In an alternative embodiment, the calculations may be performed on the sensor itself and the result of the oximetry reading may be passed to monitor 114. Further, monitor 114 may include a display 120 configured to display the physiological parameters or other information about the system.

In the embodiment shown, monitor 114 may also include a speaker 122 to provide an audible sound that may be used in various other embodiments, such as for example, sounding an audible alarm in the event that a patient's physiological parameters are not within a predefined normal range.

In an embodiment, sensor 112, or the sensor array, may be communicatively coupled to monitor 114 via a cable 124. However, in other embodiments, a wireless transmission device (not shown) or the like may be used instead of or in addition to cable 124.

In the illustrated embodiment, pulse oximetry system 110 may also include a multi-parameter patient monitor 126. The monitor may be cathode ray tube type, a flat panel display (as shown) such as a liquid crystal display (LCD) or a plasma display, or any other type of monitor now known or later developed. Multi-parameter patient monitor 126 may be configured to calculate physiological parameters and to provide a display 128 for information from monitor 114 and from other medical monitoring devices or systems (not shown). For example, multi-parameter patient monitor 126 may be configured to display an estimate of a patient's blood oxygen saturation generated by pulse oximetry monitor 114 (referred to as an “SpO₂” measurement), pulse rate information from monitor 114, and blood pressure from a blood pressure monitor (not shown) on display 128.

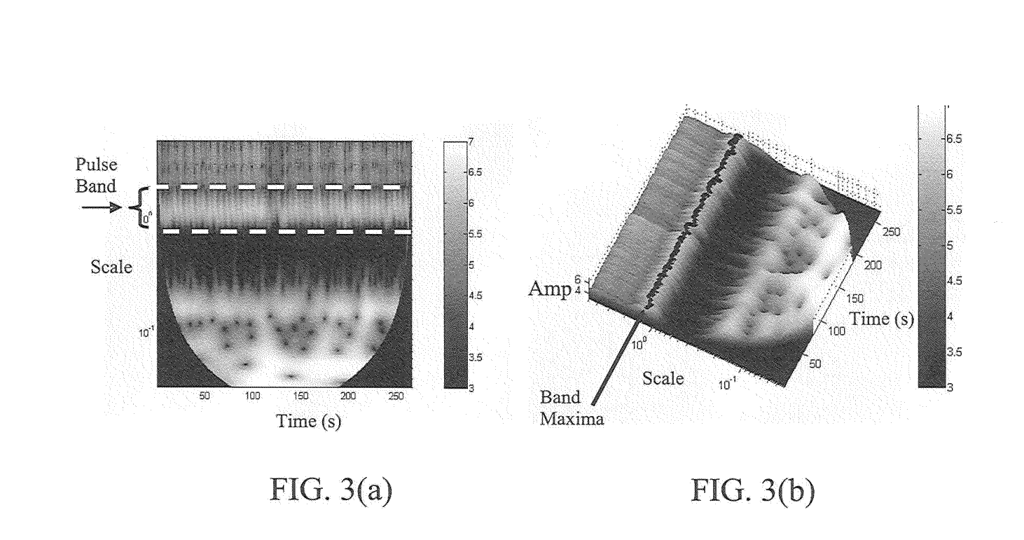

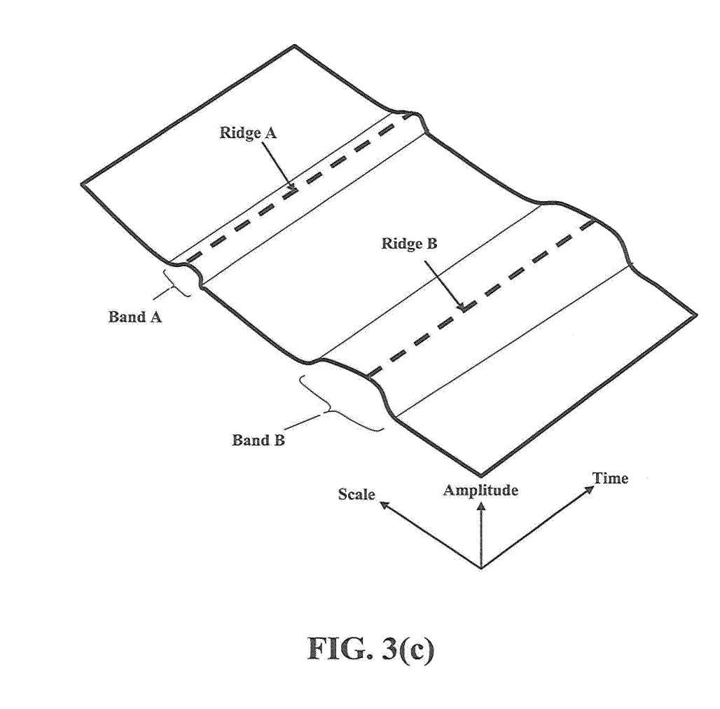

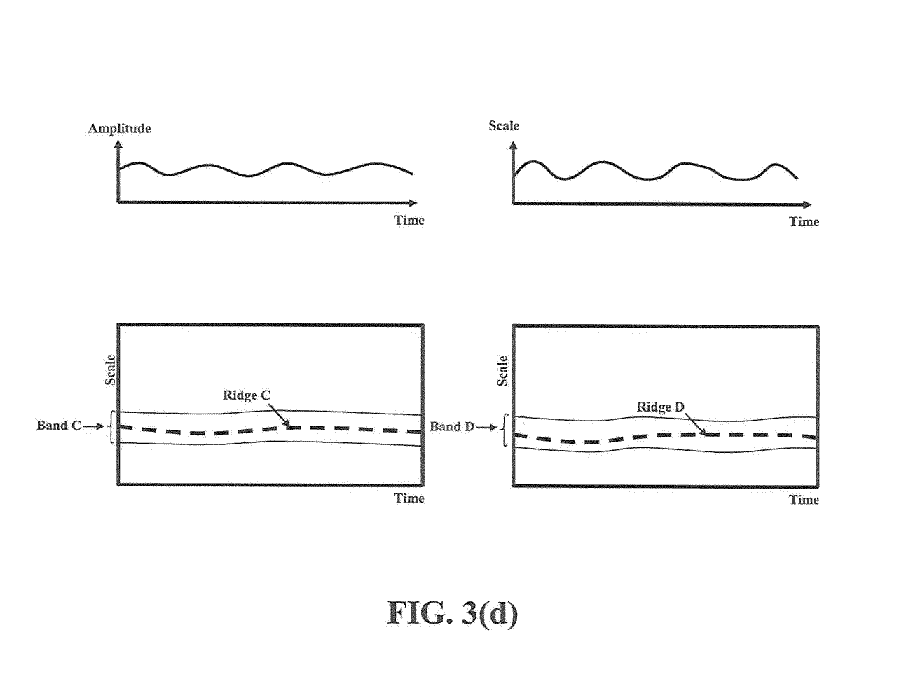

In some embodiments, the patient monitor 126 comprises or is connected to an interface, such as the host interface described in relation to FIG. 7, for depicting one or more scalograms generated by a CWT integrated circuit, for example, the CWT integrated circuit described in relation to FIGS. 4-6. The patient monitor 126 may also, in some implementations, depict the most optimal scalogram generated using a wavelet function selected as the most optimal wavelet function for the particular input signal. Display data corresponding to a scalogram may be rendered by either the integrated circuit described in connection with FIG. 3 and/or an algorithm CPU of the oximetry system described in connection with FIG. 1.

Monitor 114 may be communicatively coupled to multi-parameter patient monitor 126 via a cable 132 or 134 that is coupled to a sensor input port or a digital communications port, respectively and/or may communicate wirelessly (not shown). In addition, monitor 114 and/or multi-parameter patient monitor 126 may be coupled to a network to enable the sharing of information with servers or other workstations (not shown). Monitor 114 may be powered by a battery (not shown) or by a conventional power source such as a wall outlet.

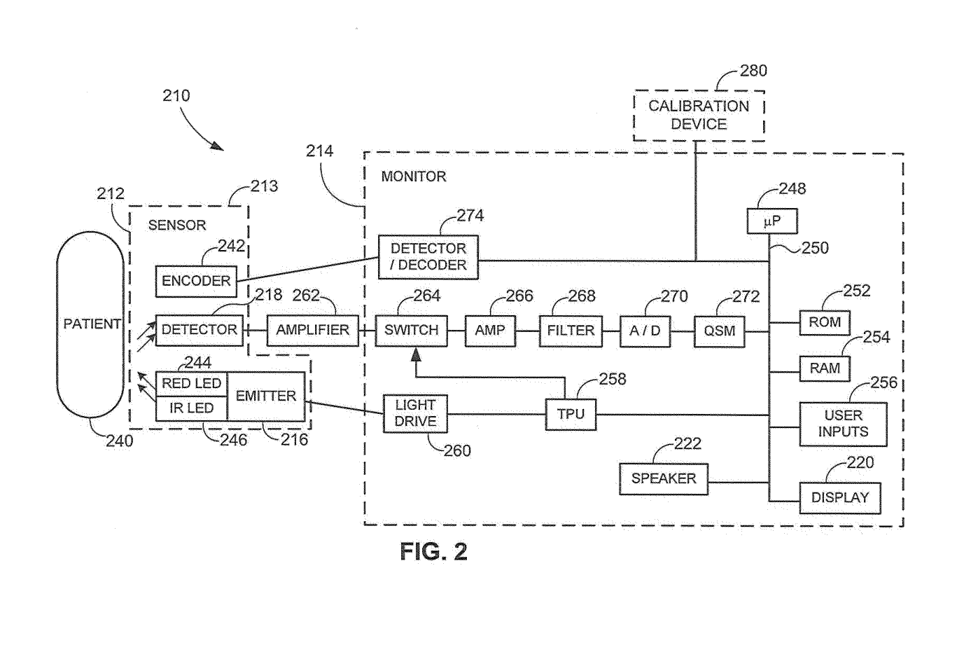

FIG. 2 is a block diagram of the illustrative pulse oximetry system of FIG. 1 coupled to a patient FIG. 2. Certain illustrative components of sensor 212 and monitor 214 are illustrated in FIG. 1. Sensor 212 may include emitter 216, detector 218, and encoder 242. In the embodiment shown, emitter 21 may be configured to emit at least two wavelengths of light (e.g., RED and IR) into a patient's tissue 240. Hence, emitter 216 may include a RED light emitting light source such as RED light emitting diode (LED) 244 and an IR light emitting light source such as IR LED 24 for emitting light into the patient's tissue 240 at the wavelengths used to calculate the patient's physiological parameters. In one embodiment, the RED wavelength may be between about 200 nm and about 700 nm, and the IR wavelength may be between about 800 nm and about 1000 nm. In embodiments where a sensor array is used in place of single sensor, each sensor may be configured to emit a single wavelength. For example, a first sensor emits only a RED light while a second only emits an IR light.

It will be understood that, as used herein, the term “light” may refer to energy produced by radiative sources and may include one or more of ultrasound, radio, microwave, millimeter wave, infrared, visible, ultraviolet, gamma ray or X-ray electromagnetic radiation. As used herein, light may also include any wavelength within the radio, microwave, infrared, visible, ultraviolet, or X-ray spectra, and that any suitable wavelength of electromagnetic radiation may be appropriate for use with the present techniques. Detector 218 may be chosen to be specifically sensitive to the chosen targeted energy spectrum of the emitter 216.

In an embodiment, detector 218 may be configured to detect the intensity of light at the RED and IR wavelengths. Alternatively, each sensor in the array may be configured to detect an intensity of a single wavelength. In operation, light may enter detector 218 after passing through the patient's tissue 240. Detector 218 may convert the intensity of the received light into an electrical signal. The light intensity is directly related to the absorbance and/or reflectance of light in the tissue 240. That is, when more light at a certain wavelength is absorbed or reflected, less light of that wavelength is received from the tissue by the detector 218. After converting the received light to an electrical signal, detector 218 may send the signal to monitor 214, where physiological parameters may be calculated based on the absorption of the RED and IR wavelengths in the patient's tissue 240.

In an embodiment, encoder 242 may contain information about sensor 212, such as what type of sensor it is (e.g., whether the sensor is intended for placement on a forehead or digit) and the wavelengths of light emitted by emitter 216. This information may be used by monitor 214 to select appropriate algorithms, lookup tables, and/or calibration coefficients stored in monitor 214 for calculating the patient's physiological parameters.

Encoder 242 may contain information specific to patient 240, such as, for example, the patient's age, weight, and diagnosis. This information may allow monitor 214 to determine, for example, patient-specific threshold ranges in which the patient's physiological parameter measurements should fall and to enable or disable additional physiological parameter algorithms. Encoder 242 may, for instance, be a coded resistor which stores values corresponding to the type of sensor 212 or the type of each sensor in the sensor array, the wavelengths of light emitted by emitter 216 on each sensor of the sensor array, and/or the patient's characteristics. In another embodiment, encoder 242 may include a memory on which one or more of the following information may be stored for communication to monitor 214: the type of the sensor 212, the wavelengths of light emitted by emitter 216, the particular wavelength each sensor in the sensor array is monitoring, a signal threshold for each sensor in the sensor array, any other suitable information, or any combination thereof.

In an embodiment, signals from detector 218 and encoder 242 may be transmitted to the dedicated CWT integrated circuit described in relation to FIGS. 4-7 directly, or indirectly via an algorithm CPU 706 of the oximetry system of FIG. 1. In the embodiment shown, monitor 214 may include a general-purpose microprocessor 248 connected to an internal bus 250. Microprocessor 248 may be adapted to execute software, which may include an operating system and one or more applications, as part of performing the functions described herein. Also connected to bus 250 may be a read-only memory (ROM) 252, a random access memory (RAM) 254, user inputs 252, display 220, and speaker 222.

RAM 254 and ROM 252 are illustrated by way of example, and not limitation. Any suitable computer-readable media may be used in the system for data storage. Computer-readable media are capable of storing information that can be interpreted by microprocessor 248. This information may be data or may take the form of computer-executable instructions, such as software applications, that cause the microprocessor to perform certain functions and/or computer-implemented methods. Depending on the embodiment, such computer-readable media may include computer storage media and communication media. Computer storage media may include volatile and non-volatile, removable and non-removable media implemented in any method or technology for storage of information such as computer-readable instructions, data structures, program modules or other data. Computer storage media may include, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by components of the system.

In the embodiment shown, a time processing unit (TPU) 258 may provide timing control signals to a light drive circuitry 260, which may control when emitter 216 is illuminated and multiplexed timing for the RED LED 244 and the IR LED 246. TPU 58 may also control the gating-in of signals from detector 218 through an amplifier 262 and a switching circuit 264. These signals are sampled at the proper time, depending upon which light source is illuminated. The received signal from detector 218 may be passed through an amplifier 266, a low pass filter 268, and an analog-to-digital converter 270. The digital data may then be stored in a queued serial module (QSM) 272 (or buffer) for later downloading to RAM 254 as QSM 72 fills up. In one embodiment, there may be multiple separate parallel paths having amplifier 266, filter 268, and A/D converter 270 for multiple light wavelengths or spectra received.

In an embodiment, microprocessor 248 may determine the patient's physiological parameters, such as SpO₂ and pulse rate, using various algorithms and/or look-up tables based on the value of the received signals and/or data corresponding to the light received by detector 218. In an embodiment, microprocessor 248 may be used for signal processing. For example, microprocessor 248 may tune a wavelet transform to a particular characteristic frequency in a scale band of interest. Signals corresponding to information about patient 240, and particularly about the intensity of light emanating from a patient's tissue over time, may be transmitted from encoder 242 to a decoder 274. These signals may include, for example, encoded information relating to patient characteristics. Decoder 274 may translate these signals to enable the microprocessor to determine the thresholds based on algorithms or look-up tables stored in ROM 252. User inputs 256 may be used to enter information about the patient, such as age, weight, height, diagnosis, medications, treatments, and so forth. In an embodiment, display 220 may exhibit a list of values which may generally apply to the patient, such as, for example, age ranges or medication families, which the user may select using user inputs 256.

The optical signal through the tissue can be degraded by noise, among other sources. One source of noise is ambient light that reaches the light detector. Another source of noise is electromagnetic coupling from other electronic instruments. Movement of the patient also introduces noise and affects the signal. For example, the contact between the detector and the skin, or the emitter and the skin, can be temporarily disrupted when movement causes either to move away from the skin. In addition, because blood is a fluid, it responds differently than the surrounding tissue to inertial effects, thus resulting in momentary changes in volume at the point to which the oximeter probe is attached.

Noise (e.g., from patient movement) can degrade a pulse oximetry signal relied upon by a physician, without the physician's awareness. This is especially true if the monitoring of the patient is remote, the motion is too small to be observed, or the doctor is watching the instrument or other parts of the patient, and not the sensor site. Processing PPG signals may involve operations that reduce the amount of noise present in the signals or otherwise identify noise components in order to prevent them from affecting measurements of physiological parameters derived from the PPG signals.

It will be understood that the present disclosure is applicable to any suitable signals and that PPG signals are used here merely for illustrative purposes. Those skilled in the art will recognize that the present disclosure has wide applicability to other signals including, but not limited to other biosignals (e.g., electrocardiogram, electroencephalogram, electrogastrogram, electromyogram, heart rate signals, pathological sounds, ultrasound, or any other suitable biosignal), dynamic signals, non-destructive testing signals, condition monitoring signals, fluid signals, geophysical signals, astronomical signals, electrical signals, financial signals including financial indices, sound and speech signals, chemical signals, meteorological signals including climate signals, and/or any other suitable signal, and/or any combination thereof.

In one embodiment, a PPG signal is transformed using a CWT integrated circuit, such as the CWT integrated circuit of FIG. 4. Information derived from the transform of the PPG signal (i.e., in wavelet space) may be used to provide measurements of one or more physiological parameters.

The continuous wavelet transform of a signal x(t) in accordance with the present disclosure may be defined as

$$T ( a , b ) = \frac{1}{\sqrt{a}} {\int }_{- ∞}^{+ ∞} x ( t ) {ψ}^{*} ( \frac{t - b}{a} ) d t \qquad ( 9 )$$

where ψ*(t) is the complex conjugate of the wavelet function ψ(t), a is the dilation parameter of the wavelet, and b is the location parameter of the wavelet. The transform given by equation (9) may be used to construct a representation of a signal on a transform surface. The transform may be regarded as a time-scale representation. Wavelets are composed of a range of frequencies, one of which may be denoted as the characteristic frequency of the wavelet, where the characteristic frequency associated with the wavelet is inversely proportional to the scale a. One example of a characteristic frequency is the dominant frequency. Each scale of a particular wavelet may have a different characteristic frequency. The underlying mathematical detail required for the implementation within a time-scale can be found, for example, in Paul S. Addison, The Illustrated Wavelet Transform Handbook (Taylor & Francis Group 2002), which is hereby incorporated by reference herein in its entirety.

The continuous wavelet transform decomposes an input signal using wavelets, which are generally highly localized in time. The continuous wavelet transform may provide a higher resolution relative to discrete transforms, thus providing the ability to garner more information from signals than typical frequency transforms such as Fourier transforms (or any other spectral techniques) or discrete wavelet transforms. Continuous wavelet transforms allow for the use of a range of wavelets with scales spanning the scales of interest of a signal such that small scale signal components correlate well with the smaller scale wavelets and thus manifest at high energies at smaller scales in the transform. Likewise, large scale signal components correlate well with the larger scale wavelets and thus manifest at high energies at larger scales in the transform. Thus, components at different scales may be separated and extracted in the wavelet transform domain. Moreover, the use of a continuous range of wavelets in scale and time position allows for a higher resolution transform than is possible relative to discrete techniques.

In addition, transforms and operations that convert a signal or any other type of data into a spectral (i.e., frequency) domain necessarily create a series of frequency transform values in a two-dimensional coordinate system where the two dimensions may be frequency and, for example, amplitude. For example, any type of Fourier transform would generate such a two-dimensional spectrum. In contrast, wavelet transforms, such as continuous wavelet transforms, are required to be defined in a three-dimensional coordinate system and generate a surface with dimensions of time, scale and, for example, amplitude. Hence, operations performed in a spectral domain cannot be performed in the wavelet domain; instead the wavelet surface must be transformed into a spectrum (i.e., by performing an inverse wavelet transform to convert the wavelet surface into the time domain and then performing a spectral transform from the time domain). Conversely, operations performed in the wavelet domain cannot be performed in the spectral domain; instead a spectrum must first be transformed into a wavelet surface (i.e., by performing an inverse spectral transform to convert the spectral domain into the time domain and then performing a wavelet transform from the time domain). Nor does a cross-section of the three-dimensional wavelet surface along, for example, a particular point in time equate to a frequency spectrum upon which spectral-based techniques may be used. At least because wavelet space includes a time dimension, spectral techniques and wavelet techniques are not interchangeable. It will be understood that converting a system that relies on spectral domain processing to one that relies on wavelet space processing would require significant and fundamental modifications to the system in order to accommodate the wavelet space processing (e.g., to derive a representative energy value for a signal or part of a signal requires integrating twice, across time and scale, in the wavelet domain while, conversely, one integration across frequency is required to derive a representative energy value from a spectral domain). As a further example, to reconstruct a temporal signal requires integrating twice, across time and scale, in the wavelet domain while, conversely, one integration across frequency is required to derive a temporal signal from a spectral domain. It is well known in the art that, in addition to or as an alternative to amplitude, parameters such as energy density, modulus, phase, among others may all be generated using such transforms and that these parameters have distinctly different contexts and meanings when defined in a two-dimensional frequency coordinate system rather than a three-dimensional wavelet coordinate system. For example, the phase of a Fourier system is calculated with respect to a single origin for all frequencies while the phase for a wavelet system is unfolded into two dimensions with respect to a wavelet's location (often in time) and scale.

The energy density function of the wavelet transform, also known as a scalogram, is defined as

S(a,b)=|T(a,b)|² (10)

where ‘∥’ is the modulus operator. The scalogram may be resealed for useful purposes. One common resealing is defined as

$${S}_{R} ( a , b ) = \frac{{\vert T ( a , b ) \vert}^{2}}{a} \qquad ( 11 )$$

and is useful for defining ridges in wavelet space when, for example, the Monet wavelet is used. Ridges are defined as the locus of points of local maxima in the plane. Any reasonable definition of a ridge may be employed in the method. Also included as a definition of a ridge herein are paths displaced from the locus of the local maxima. A ridge associated with only the locus of points of local maxima in the plane are labeled a “maxima ridge.”

For implementations requiring fast numerical computation, the wavelet transform may be expressed as an approximation using Fourier transforms. Pursuant to the convolution theorem, because the wavelet transform is the cross-correlation of the signal with the wavelet function, the wavelet transform may be approximated in terms of an inverse FFT of the product of the Fourier transform of the signal and the Fourier transform of the wavelet for each required a scale and then multiplying the result by \sqrt{a}. The FFT of an input signal and/or an approximation thereof may be carried out by the integrated circuit of FIGS. 4-6.

In the discussion of the technology which follows herein, the “scalogram” may be taken to include all suitable forms of resealing including, but not limited to, the original unsealed wavelet representation, linear resealing, any power of the modulus of the wavelet transform, or any other suitable resealing. In addition, for purposes of clarity and conciseness, the term “scalogram” shall be taken to mean the wavelet transform, T(a,b) itself, or any part thereof. For example, the real part of the wavelet transform, the imaginary part of the wavelet transform, the phase of the wavelet transform, any other suitable part of the wavelet transform, or any combination thereof is intended to be conveyed by the term “scalogram.”

A scale, which may be interpreted as a representative temporal period, may be converted to a characteristic frequency of the wavelet function. The characteristic frequency associated with a wavelet of arbitrary a scale is given by

$$f = \frac{{f}_{c}}{a} \qquad ( 12 )$$

where f_{c}, the characteristic frequency of the mother wavelet (i.e., at a=1), becomes a scaling constant and f is the representative or characteristic frequency for the wavelet at arbitrary scale a.

Any suitable wavelet function may be used in connection with the present disclosure. One of the most commonly used complex wavelets, the Morlet wavelet, is defined as:

ψ(t)=π^{-1/4}(e^{i2πf}^{₀}^{t}−e^{-(2πf}^{₀}⁾^{²}^{/2} (13)

where f₀ is the central frequency of the mother wavelet. The second term in the parenthesis is known as the correction term, as it corrects for the non-zero mean of the complex sinusoid within the Gaussian window. In practice, it becomes negligible for values of f₀>>0 and can be ignored, in which case, the Morlet wavelet can be written in a simpler form as

$$ψ ( t ) = \frac{1}{{π}^{1 / 4}} {e}^{i 2 π {f}_{0} t} {e}^{- {t}^{2} / 2} \qquad ( 14 )$$

This wavelet is a complex wave within a scaled Gaussian envelope. While both definitions of the Morlet wavelet are included herein, the function of equation (14) is not strictly a wavelet as it has a non-zero mean (i.e., the zero frequency term of its corresponding energy spectrum is non-zero). However, it will be recognized by those skilled in the art that equation (14) may be used in practice with f₀>>0 with minimal error and is included (as well as other similar near wavelet functions) in the definition of a wavelet herein. A more detailed overview of the underlying wavelet theory, including the definition of a wavelet function, can be found in the general literature.

Pertinent repeating features in a signal give rise to a time-scale band in wavelet space or a resealed wavelet space. For example, the pulse component of a PPG signal produces a dominant band in wavelet space at or around the pulse frequency. FIGS. 3(a) and 3(b) show illustrative views of a scalogram derived from a CWT of a PPG signal computed using a CWT integrated circuit described in relation to FIGS. 4-6. The figures show an example of the band caused by the pulse component in such a signal. The pulse band is located between the dashed lines in the plot of FIG. 3(a). The band is formed from a series of dominant coalescing features across the scalogram. This can be clearly seen as a raised band across the transform surface in FIG. 3(b) located within the region of scales indicated by the arrow in the plot (corresponding to 60 beats per minute). The maxima of this band with respect to scale is the ridge. The locus of the ridge is shown as a black curve on top of the band in FIG. 3(b). By employing a suitable resealing of the scalogram, such as that given in equation (11), the ridges found in wavelet space may be related to the instantaneous frequency of the signal. In this way, the pulse rate may be obtained from the PPG signal. Instead of resealing the scalogram, a suitable predefined relationship between the scale obtained from the ridge on the wavelet surface and the actual pulse rate may also be used to determine the pulse rate.

By mapping the time-scale coordinates of the pulse ridge onto the wavelet phase information gained through the wavelet transform, individual pulses may be captured. In this way, both times between individual pulses and the timing of components within each pulse may be monitored and used to detect heart beat anomalies, measure arterial system compliance, or perform any other suitable calculations or diagnostics. Alternative definitions of a ridge may be employed. Alternative relationships between the ridge and the pulse frequency of occurrence may be employed.

As discussed above, pertinent repeating features in the signal give rise to a time-scale band in wavelet space or a resealed wavelet space. For a periodic signal, this band remains at a constant scale in the time-scale plane. For many real signals, especially biological signals, the band may be non-stationary; varying in scale, amplitude, or both over time. FIG. 3(c) shows an illustrative scalogram derived from a signal containing two pertinent components using a CWT integrated circuit described in relation to FIGS. 4-6. These bands are labeled band A and band B on the three-dimensional schematic of the wavelet surface. In this embodiment, the band ridge is defined as the locus of the peak values of these bands with respect to scale. For purposes of discussion, it may be assumed that band B contains the signal information of interest. This will be referred to as the “primary band.” In addition, it may be assumed that the system from which the signal originates, and from which the transform is subsequently derived, exhibits some form of coupling between the signal components in band A and band B. When noise or other erroneous features are present in the signal with similar spectral characteristics of the features of band B then the information within band B can become ambiguous (i.e., obscured, fragmented or missing). In this case, the ridge of band A may be followed in wavelet space and extracted either as an amplitude signal or a scale signal which will be referred to as the “ridge amplitude perturbation” (RAP) signal and the “ridge scale perturbation” (RSP) signal, respectively. The RAP and RSP signals may be extracted by projecting the ridge onto the time-amplitude or time-scale planes, respectively. The top plots of FIG. 3(d) shows an illustrative schematic of signals associated with a ridge in FIG. 3(c) and illustrative schematics of a further wavelet decomposition of these associated signals. Below these RAP and RSP signals are schematics of a further wavelet decomposition of these newly derived signals. This secondary wavelet decomposition allows for information in the region of band B in FIG. 3(c) to be made available as band C and band D. The ridges of bands C and D may serve as instantaneous time-scale characteristic measures of the signal components causing bands C and D. This technique, which will be referred to herein as secondary wavelet feature decoupling (SWFD), may allow information concerning the nature of the signal components associated with the underlying physical process causing the primary band B (FIG. 3(c)) to be extracted when band B itself is obscured in the presence of noise or other erroneous signal features.

In some instances, an inverse continuous wavelet transform may be desired, such as when modifications to a scalogram (or modifications to the coefficients of a transformed signal) have been made in order to, for example, remove artifacts. In one embodiment, there is an inverse continuous wavelet transform which allows the original signal to be recovered from its wavelet transform by integrating over all scales and locations, a and b:

$$x ( t ) = \frac{1}{{C}_{g}} {\int }_{- ∞}^{∞} {\int }_{0}^{∞} T ( a , b ) \frac{1}{\sqrt{a}} Ψ ( \frac{t - b}{a} ) \frac{d a d b}{{a}^{2}} \qquad ( 15 )$$

which may also be written as:

$$x ( t ) = \frac{1}{{C}_{g}} {\int }_{- ∞}^{∞} {\int }_{0}^{∞} T ( a , b ) {Ψ}_{a , b} ( t ) \frac{d a d b}{{a}^{2}} \qquad ( 16 )$$

where C_{g} is a scalar value known as the admissibility constant. It is wavelet type dependent and may be calculated from:

$${C}_{g} = {\int }_{0}^{∞} \frac{{\vert \hat{ψ} ( f ) \vert}^{2}}{f} d f \qquad ( 17 )$$

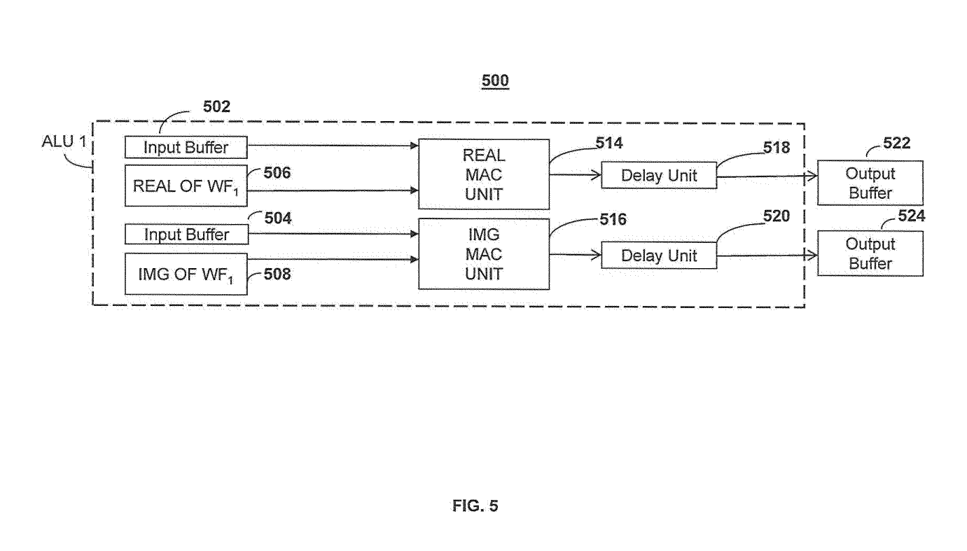

FIG. 4(a) shows a block diagram of an architecture of an integrated circuit (“IC”) 400 for computing one or more CWTs of an input signal using one or more types of wavelet functions. Details of the computation of a single CWT using a single type of wavelet function are described in relation to FIG. 5. The integrated circuit 400 comprises an input buffer 402, arithmetic logic units (“ALUs”) 404, and an output buffer 408. Integrated circuit 400 or a portion thereof may be implemented in an field-programmable gate array (FPGA), application-specific integrated circuit (ASIC), or any other IC fabrication technology.

In operation, input buffer 402 receives samples corresponding to an input signal, such as a signal detected by a pulse oximetry sensor. The methods by which such an input signal is acquired and sampled are discussed in connection with FIGS. 1 and 7. The data from input buffer 402 are provided to each of the ALUs 404 to be processed in parallel. Each ALU computes the CWT of the input signal in parallel using a wavelet function at a particular scale. By performing a CWT at different scales on different ALUs, in parallel, the execution time for computing the overall wavelet transform may be significantly reduced. In one embodiment, ALUs 404 compute a CWT using a single wavelet function (e.g., Mexican Hat wavelet, Morlet wavelet) across a range of scales. The output CWT may be stored in output buffer 408. Alternatively, the IC 400 may further compute the scalogram, the phase plot, or any other representation or derivation of the CWT.

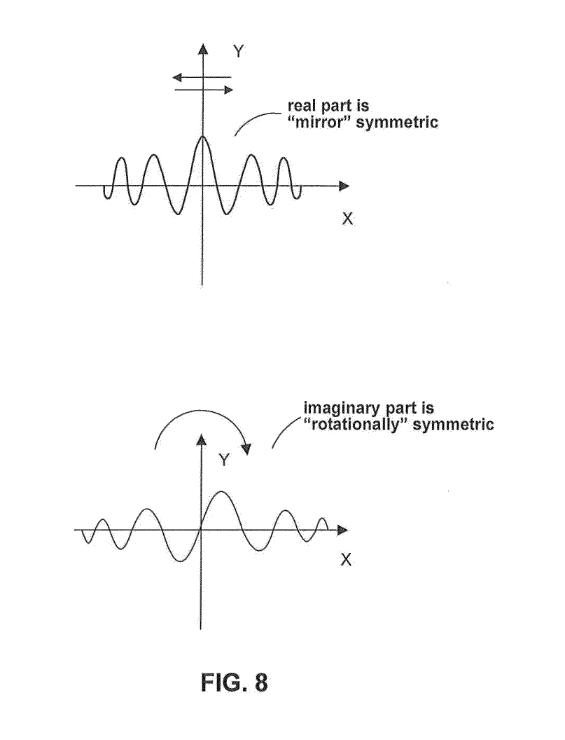

In another embodiment, ALUs 404 may be grouped such that each group uses a different wavelet function to compute a CWT of the input signal across multiple different scales. For example, the first group may use a Morlet wavelet while the second group uses a Mexican Hat wavlet. Computing multiple CWTs using a variety of different types of wavelet functions may be advantageous because different types of wavelet functions have different mathematical characteristics, making some more suitable than others for extracting certain types of information (e.g., physiological parameters) from an input signal. For example, the Morlet wavelet may be more suitable than the Mexican Hat wavelet for extracting useful information or parameters from an EEG signal. Examples of different types of wavelet functions are discussed in relation to FIG. 8.

In such an embodiment, the IC 400 may output all of the CWTs or it may contain selection logic such that it selects a particular CWT to output based on selection criteria. Such criteria may be hard-wired into the IC 400 or user-programmable. In some embodiments, a user is given the option to select the most optimal CWT values, or scalograms. In these embodiments, scalograms corresponding to CWT values computed using different wavelet functions are presented to a user via a user interface. The user can select the most optimal CWT results based on the presented scalograms. In other embodiments, selection circuitry selects the optimal CWT results according to certain methods and/or pre-defined rules and parameters. These rules and parameters may be programmed into the IC 400 at the circuit-level. In other embodiments, the selection circuitry pre-selects one of the several different types of wavelet functions as most suitable for a particular task to avoid computing CWTs using several different types of the wavelet functions.

FIG. 5 shows a detailed block diagram 500 of a single ALU 420. The diagram shows an ALU for calculating a complex CWT, and as a result, it has two parallel computation pathways. The first pathway is used for the real part of the CWT and the second for the imaginary part. This arrangement is shown to illustrate the calculation of a complex CWT by an ALU. In other embodiments, the real and imaginary parts of a complex CWT are calculated by two separate ALUs. For real CWTs (i.e., those having no imaginary part), a single ALU may be able to perform the entire calculation at a particular scale.

The ALU of FIG. 5 comprises input buffers 502 and 504, wavelet function memories 506 and 508, multiply-and-accumulate (MAC) units 514 and 516, delay units 518 and 520, and output buffers 522 and 524.

Input buffers 502 and 504 contain samples from an input signal to be transformed. Depending on the application, input buffers 502 and 504 may receive one sample at a time or a group of samples. Input buffers 502 and 504 may be first-in-first-out (FIFO) buffers, such that when a new sample is added, the oldest sample stored in the buffer is removed.

Wavelet function memories 506 and 508 store pre-computed, scaled versions of a wavelet function. Memory 506 stores the real part of the wavelet function and memory 508 stores the imaginary part. Memories 506 and 508 may be part of a larger addressable memory unit or individual memory units associated with the particular ALUs. Memories 506 and 508 may be user programmable, such that the user may change the stored wavelet functions. In such embodiments, the user may input a single wavelet (e.g., the wavelet function at scale a=1) and circuitry on the IC may pre-compute and store the desired scales in the different ALUs. Memories 506 and 508 may also be static and factory-programmed.

By pre-determining and storing scaled versions of a wavelet function in memory 408, the time required to compute a CWT can be reduced because the IC 400 does not have to scale the wavelet function in real-time. In some embodiments, where the wavelet function is symmetrical, memories 506 and 508 may store only part of the wavelet function. For example, for a wavelet function that displays mirror symmetry, memories 506 and 508 may only need to store one half of the function. The mathematical symmetry of the real and imaginary parts of a wavelet function is further described in relation to FIG. 8. In these embodiments, after reading in data from the memory 408 and before computing a CWT, the ALUs 420 may re-construct the complete wavelet function from the symmetrical portions stored in memory. In other embodiments, the ALU may perform the necessary computations using only the stored portions of the wavelet function 408, without reconstructing the remaining portions.

In some embodiments, the storage units, such as the input buffers 502 and 504 and wavelet memories 506 and 508, may be dynamically sizable. For example, the storage units may be part of a larger memory circuit that is dynamically addressed by each ALU. In some instances, a main processor, such as the one described below in relation to FIG. 7 is connected to the integrated circuit 400 to determine the bit-size of each buffer based on, for example, the anticipated size or number of the input samples. This is important because the amount of data that can be queued in the input buffers 502 and 504 depends on the bit-size of these buffers and/or the size and speed of the bus connected to the buffers 502 and 504, both of which may also affect the speed at which the computation of a CWT can be carried out. There are several design parameters that can be taken into consideration to further speed up the CWT computation process. These parameters may comprise, for example, the bit-size of the MAC unit 514 and 516, and the speed at which a scaled wavelet function is translated or time-shifted

In operation, input buffers 502 and 504 store samples from the input signal. Real MAC unit 514 calculates the dot product of the input signal stored in input buffer 502 and the real part of the scaled wavelet function stored in memory 506. If memory 506 stores only a portion of a symmetrical wavelet function, MAC unit 514 may compensate by, for example, taking the values for the left half of the wavelet function from the stored right half. Similarly, imaginary MAC unit 516 calculates the dot product of the input signal stored in input buffer 504 and the imaginary part of the scaled wavelet function stored in memory 506. MAC units 514 and 516 thus output the real and imaginary part of a complex number corresponding to a CWT at a given scale.

After a set of multiplications, various operations may be performed to effect a change in the translation parameter b. In one embodiment, a new sample from the input signal is shifted into input buffers 502 and 504 and the oldest sample is shifted out. The operations discussed above are then repeated, generating a new set of output values for each scale. In another embodiment, either the input signal or the wavelet function may be shifted and/or rotated to effect a translation, eg., b, between the wavelet function and the input signal. This may be done multiple times for each input signal in order to build a CWT of the input signal across multiple different translation parameters. Output buffers 522 and 524 may store all of these CWT values in a two-dimensional array in memory, which may be used to construct a three-dimensional scalogram. In other embodiments, the multiplication and translation steps are repeated for a specified number of times. For example, the user may be given a plot of the input data on a screen and selects a portion of the input data for which a CWT is needed. As such, a CWT is computed only for the time period that corresponds to the portion of input data selected by the user.

It should be recognized that the size of the input buffers 502 and 504 and the size of the wavelet function memories 506 and 508 may be different for different wavelet scales due to the changing temporal support of the wavelet at different scales. Accordingly, delay unit 518 may be required to delay the output of each ALU to ensure that it is synchronized with ALUs calculating different scales for the same wavelet function. Alternatively, the ALUs may be configured to operate asynchronously.

Some wavelets are complex, having both a real and imaginary components, while other wavelets are real-valued wavelets. As an example, FIG. 8 shows plots of the real and imaginary parts of a complex wavelet. Computing a continuous wavelet transform preferably uses a complex wavelet. The computation would, therefore, require taking the dot product of an input signal with both the real and imaginary component of a wavelet. To compute a true continuous wavelet transform, a complex wavelet is used, in contrast with a discrete wavelet transform, where a real-valued wavelet is used. Computing a CWT using a complex wavelet having both a real and imaginary component can be advantageous as it provides high data redundancy (richer sets of data) and, hence, more reliable transform results. However, calculating both a real and imaginary component of a wavelet is also highly processor-intensive, particularly in comparison to a discrete wavelet transform, which uses approximated real-valued wavelets. By separating the computation of the real components of a wavelet from the computation of its imaginary components and executing their respective computations in parallel, as designed into the architecture of the integrated circuit 400, computation time is substantially reduced and a true continuous wavelet transform can be calculated in real-time.

In some embodiments, the architectural design of the integrated circuit 400 is modular. As such, additional ALUs may be added to compute the CWT of an input signal at additional scales or using additional wavelet functions with minimal change to the overall computation time. In some embodiments, the number of scales can be defined by the user when programming the configuration of the integrated circuit 400. In those embodiments, the number of modules may be allocated according to the number of scales defined by the user. The integrated circuit 400 may be adapted to comprise any additional circuitry (i.e., additional modules) to carry out any additional computation steps described in relation to FIGS. 4-5.

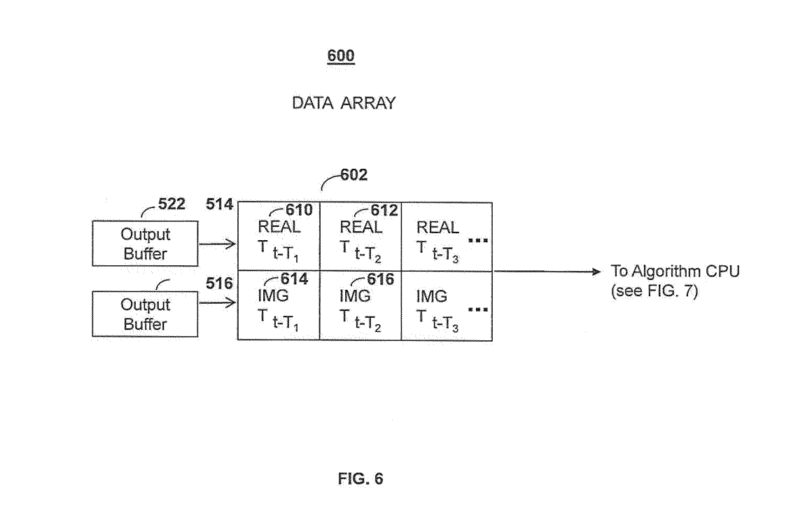

FIG. 6 shows a block diagram of data arrays 600 for storing computed CWT values of an input signal. The data arrays 602 are for storing data associated with a CWT of an input signal as computed by the ALUs 404. In some embodiments, the data associated with a CWT are processed in real-time to compute the CWT of an input signal without being stored in the data arrays 602.

In operation, The data arrays 602 are partitioned into two parts to store the real part of the CWT data separately from the imaginary part of the CWT data. For example, the real part of the CWT data of the input signal at a first scale and a first time period (e.g., a=1, and b=T₁) are stored in cell 610 of the 2-D array 602. Similarly, the imaginary part of the CWT data of the input signal at a=1 and b=T₁ may be stored in cell 614 of the data arrays 602.

FIG. 7 is a system level block diagram of an OEM module 700 that uses the CWT integrated circuit 400 described in relation to FIGS. 4-6 to extract one or more physiological parameters of an input signal in accordance with some embodiments. The OEM module 700 comprises a sensor interface 702, an A/D converter/front-end CPU 704, an algorithm CPU 706, a CWT integrated circuit 400, and a host interface 708. The sensor interface 702 may be connected to or made part of the oximeter system described above in relation to FIG. 1.

In operation, the sensor interface 702 receives an analog input signal and transmits it to the A/D converter/front-end CPU 704. Details of the operation of the sensor interface 702 in relation to other components of a medical instrument for collecting physiological signals, such as EEG, are described, for example, in relation to FIGS. 1 and 2. The A/D converter/front-end CPU 704 receives the input signal and samples it at a certain sampling rate to convert the analog signal into digital data. In some embodiments, the front-end CPU portion of the A/D converter/front-end CPU 704 pre-processes the input signal by, for example, filtering the signal to improve the signal-to-noise ratio. The digitized samples corresponding to the input signal are then sent to the algorithm CPU 706, which, in some instances, is the main algorithm or CPU of a biomedical instrument, such as the device described in relation to FIGS. 1 and 2. The CPU 706 transmits the digital samples of the input signal to the CWT integrated circuit 400 for carrying out the computation of the CWT of the input signal as described above. In some implementations, CPU 706 receives a set of CWT values (representing a set of scales and a particular translation parameter) from CWT IC 400 in response to each individual sample it transmits, thus implementing a running CWT over the input signal. Such an implementation may be suitable to allow CPU 706 to present a real-time scrolling display of the CWT of the input signal. In another implementation, CPU 706 may transmit multiple samples to CWT IC 400 at once (representing the input signal over an extended period of time) and, in return, receive CWT values corresponding to several scales and translation parameters. Such an implementation may be suitable when CPU 706 requires a CWT of a stored input signal spanned over an extended period of time.

CPU 706 may also send and receive control parameters from the CWT IC 400. Such control parameters may, for example, control the scales over which a CWT is computed, provide the wavelet functions to use in a CWT, define the length of the buffers to use in the CWT, or set any other parameter that may be varied by CWT IC 400.

The CPU 706 may be implemented on the same chip as the CWT integrated circuit 400. In such an embodiment, resources dedicated to the algorithm CPU 706, such as direct memory for the CPU 706, are accessible by the integrated circuit 400. In other embodiments, the CWT IC 400 may be externally connected to CPU 706 and/or any other device via, for example, a shared bus, processor interconnect, serial port, or USB port. In some embodiments, the integrated circuit 400 is implemented to be used as a co-processor to perform other computationally intensive operations for CPU 706, in addition to carrying out the computation of a CWT.

As mentioned above, the integrated circuit 400 may be implemented on a FPGA. In such an embodiment, a programmer may configure the logic in the integrated circuit 400 via an application that runs on CPU 706. The configuration of the various combinational and/or sequential logic gates used in CWT IC 400 can be either defined in code or according to certain circuit diagrams, both of which may require a software application, which may be executed by CPU 706. CWT IC 400 may be designed using low-level programming language, or a hardware description language, such as VHDL. In addition to configuring CWT IC 400, the IC memory may also be flashed and/or updated with new data via CPU 706.

FIG. 8 shows a schematic of a wavelet function used in, for example, the CWT system described in relation to FIGS. 4-6. As depicted in FIG. 8, the wavelet is complex, having a real part and an imaginary part. Each part is plotted in FIG. 8. The real part of the wavelet is mirror-symmetric with respect to the y-axis. The imaginary part of the wavelet is rotationally-symmetric with respect to the x-axis. That is, the function appears the same when it is rotated 180 degrees with respect to the origin. As mentioned above, the mathematical symmetry of this and other wavelet functions allows the integrated circuit 400 to re-construct the full wavelet function while storing on half of its values. The depicted wavelet function is purely illustrative. Other types of wavelet functions include Morlet wavelet, Mexican hat wavelet, Shannon wavelet, Hermitian wavelet, Hermitian Hat wavelet, Beta wavelet, Causal wavelet, Cauchy wavelet, and Addison wavelet. In some embodiments, a user can define his/her wavelet function. As described above, CWT IC 400 can compute, in parallel, the CWT of an input signal using any wavelet function.

It will be understood that the systems and methods described herein may also comprise any combination of the above-described embodiments. Additionally, the systems and methods described herein (for example, any of the systems for computing the CWT of an input signal using a variety of wavelet functions as described in FIGS. 4-6) may be applied to time domain signals, wavelet domain signals, signals in any suitable domain, or any combination thereof. It will also be understood that the above method and system may be easily modified to compute other transforms of the input signal, such as Fourier transforms, and Laplace transforms, etc. The above method and system may also compute inverse transforms to recover an original time-varying input signal based from its transform.

The foregoing is merely illustrative of the principles of this disclosure and various modifications can be made by those skilled in the art without departing from the scope and spirit of the disclosure. The following claims may also describe various aspects of this disclosure.

What is Claimed is:

1. A system for computing a continuous wavelet transform, comprising:
an integrated circuit having a receiver, memory, and processing circuitry;
the receiver being configured to receive input data corresponding to an input signal;
the memory being configured to store information corresponding to a wavelet function scaled over a set of scales; and
the processing circuitry being configured to compute, in parallel, portions of a continuous wavelet transform of the input signal based on the received input data and the stored information corresponding to the wavelet function.

2. The system of claim 1, wherein the processing circuitry comprises a plurality of arithmetic logic units, wherein each ALU is configured to compute the continuous wavelet transform of the input signal using the wavelet function at a particular scale.

3. The system of claim 2, wherein each ALU comprises at least one buffer for storing an input signal from the receiver, at least one memory element that stores information corresponding to a first scaled version of a wavelet function, and at least one multiply-and-accumulate unit connected to the buffer and the memory element.

4. The system of claim 3, wherein the at least one multiply-and-accumulate unit is configured to compute a dot product of a scaled version of the wavelet function and the input data to generate a resultant CWT value.

5. The system of claim 1, wherein the wavelet function comprises one of Morlet wavelet, a Mexican hat wavelet, Shannon wavelet, Hermitian wavelet, Hermitian hat wavelet, Beta wavelet, Causal Wavelet, Cauchy wavelet, Addison wavelet, and a user-defined wavelet function.

6. The system of claim 1, wherein the stored information in memory comprises half of a real and an imaginary part of a scaled version of the wavelet function using which a full real and imaginary part of the scaled wavelet function is constructed.

7. The system of claim 1, wherein the system is implemented on at least one of a Field-Programmable-Gate-Array (FPGA) and an Application Specific Integrated Circuit (ASIC).

8. A method for computing a continuous wavelet transform, comprising:
receiving input data corresponding to an input signal;
storing in memory information corresponding to a wavelet function scaled over a set of scales; and
computing, in-parallel, portions of the continuous wavelet transform of the input signal based on the received input data and the stored information corresponding to the wavelet function.

9. The method of claim 8, further comprising computing the continuous wavelet transform of the input signal using a wavelet function at a particular scale.

10. The method of claim 8, further comprising computing a dot product of a scaled version of the wavelet function and the input data to generate a resultant continuous wavelet transform value.

11. The method of claim 8, wherein the wavelet function comprises one of Morlet wavelet, a Mexican hat wavelet, Shannon wavelet, Hermitian wavelet, Hermitian hat wavelet, Beta wavelet, Causal wavelet, Cauchy wavelet, Addison wavelet, and a user-defined wavelet function.

12. The method of claim 8, further comprising storing in the memory half of a real and an imaginary part of a scaled version of the single wavelet function using which a full real and imaginary part of the scaled wavelet function is constructed.

13. The method of claim 8, further comprising performing the continuous wavelet transform of the input signal on at least one of a Field-Programmable-Gate-Array (FPGA) and an Application Specific Integrated Circuit (ASIC).

14. A system for one or more wavelet transforms, comprising:
an integrated circuit having a receiver, memory, and processing circuitry;
the receiver being configured to receive input data corresponding to an input signal;
the memory being configured to store information corresponding to one or more wavelet functions scaled over one or more sets of scales; and
the processing circuitry being configured to compute, in parallel, a separate continuous wavelet transform of the input signal for each of the one or more wavelet functions based on the received input data and stored information corresponding to each of the one or more wavelet functions scaled over the one or more sets of scales.

15. The system of claim 14, wherein the processing circuitry comprises one or more processing units, each including one or more arithmetic logic units for computing the continuous wavelet transform at one or more scales.

16. The system of claim 15, wherein the one or more processing units output to a user interface one or more scalograms corresponding to the one or more wavelet transforms computed using the one or more wavelet functions.

17. The system of claim 14, wherein the processing circuitry further comprises circuitry corresponding to a selector configured to select one of the one or more wavelet functions as a most optimal wavelet function for the input signal.

18. A method for computing one or more continuous wavelet transforms, comprising:
receiving input data corresponding to an input signal;
storing in memory information corresponding to one or more wavelet functions scaled over one or more sets of scales; and
computing, in parallel, a separate continuous wavelet transform of the input signal for each of the one or more wavelet functions based on the received input data and stored information corresponding to each of the one or more wavelet functions scaled over the one or more sets of scales.

19. The method of claim 18, further comprising outputting to a user interface one or more scalograms corresponding to the one or more wavelet transforms computed using the one or more wavelet functions.

20. The method of claim 18, further comprising selecting one of the one or more wavelet functions as a most optimal wavelet function for the input signal.
